(19) United States
(12) Patent Application Publication
(10) Pub. No.: US 2005/0044153 A1
(43) Pub. Date: Feb. 24, 2005

(54) Email processing system

(76) Inventor: William Gross, Pasadena, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/867,276

(22) Filed: Jun. 14, 2004

Related U.S. Application Data
(60) Provisional application No. 60/477,893, filed on Jun. 12, 2003.

(51) Int. Cl. G06F 15/16

(52) U.S. Cl. 709/206; 709/207

(57) ABSTRACT

In accordance with the foregoing, in one embodiment of the present invention, an email processing system comprises a first database configured to store a user's email routing preferences. The system further comprises a second database configured to store registration information on paying email senders. The system further comprises email identification analysis code configured to determine whether an incoming email is commercial bulk email. The system further comprises email routing code configured to selectively deliver the incoming email to a folder or to delete the incoming email. The email routing code routes email based at least partially on the user's email routing preferences, the determination of the email identification analysis code, and the email sender registration information.

### PRIORITY CLAIM

This application claims the benefit of U.S. Provisional Application No. 60/477,893, filed 12 Jun. 2003. The entire contents of this priority application is hereby incorporated by reference herein.

### FIELD OF THE INVENTION

The present invention relates generally to an email processing system capable of routing incoming email based on sender registration status and addressee defined preferences.

### BACKGROUND OF THE INVENTION

Marketers often send vast amounts of commercial electronic mail (“email”), usually in an effort to reach potential customers. Such commercial bulk email (“CBE”), which can be solicited or unsolicited by the addressee, is commonly referred to as “spam email”. Because of its unsolicited nature, the content of CBE is often, although not always, of little interest to the recipient. Given the high volume of CBE and the low relevancy to many users, the task of reviewing and filtering CBE can be time-consuming, frustrating, and even deleterious at times. For example, a CBE will occasionally deceive the recipient as to the origin or purpose of the email, thereby attracting sustained attention from the user, and will perhaps even succeed in defrauding the recipient at times. In other instances, an actual important email will be overlooked in the high volume of CBE. Additionally, the high volume of CBE often causes computer users and network administrators, especially Internet service providers, to invest significant computing resources in handling CBE.

Consequently, many computer users have attempted to forego the task of reviewing CBE by installing CBE filters configured to route CBE to a “junk folder” that is periodically emptied, often on an automated basis. Network administrators have implemented similar techniques at the Internet service provider level in an effort to prevent CBE from reaching individual users. These approaches often reduce or eliminate the hassle of reading and filtering large volumes of CBE on a regular basis. Other proposals for reducing the volume of CBE involve implementing an email postage system wherein all senders or all senders of unsolicited email are required to pay a postage fee to have an email message delivered. Postage based CBE reduction systems operate on the principle that the cost of paying postage may discourage the sending of CBE.

### SUMMARY OF THE INVENTION

In accordance with the foregoing, in one embodiment of the present invention, an email processing system comprises a first database configured to store a user's email routing preferences. The system further comprises a second database configured to store registration information on paying email senders. The system further comprises email identification analysis code configured to determine whether an incoming email is commercial bulk email. The system further comprises email routing code configured to selectively deliver the incoming email to a folder or to delete the incoming email. The email routing code routes email based at least partially on the user's email routing preferences, the determination of the email identification analysis code, and the email sender registration information. The email routing code is configured to deliver the incoming email to a junk folder if the email identification analysis code determines that the incoming email is commercial bulk email, the email sender is a paying sender, and the user's email routing preferences indicate that commercial bulk email from a paying sender is to be delivered to the junk mail folder. The folder is an inbox folder or the junk mail folder.

In another embodiment of the present invention, a method for processing email comprises receiving an incoming email addressed to a recipient. The method further comprises identifying a sender of the incoming email and determining if the sender is a paying sender. The method further comprises determining if the recipient has elected to receive nonpaying email from the sender. The method further comprises determining if the recipient has elected to receive commercial bulk email from paying senders. The method further comprises determining if the incoming email is commercial bulk email. If the incoming email is not determined to be commercial bulk email, the method further comprises delivering the incoming email to an inbox folder. If the incoming email is determined to be commercial bulk email, the method further comprises (a) delivering the incoming email to a junk mail folder if the sender is not a paying sender and if the recipient has not elected to receive nonpaying email from the sender, (b) delivering the incoming email to an inbox folder if the sender is not a paying sender and if the recipient has elected to receive nonpaying email from the sender, (c) delivering the incoming email to a junk mail folder if the sender is a paying sender and if the recipient has not elected to receive paying email from the sender, or (d) delivering the incoming email to an inbox folder if the sender is a paying sender and if the recipient has elected to receive paying email from paying senders.

In another embodiment of the present invention, an apparatus comprises code. When executed, the code is configured to deliver an incoming email to an inbox folder or a junk mail folder. The determination is based on first and second user preference settings. The first user preference setting controls whether an email recipient receives nonpaying emails from a particular sender. The second user preference setting controls whether an email recipient receives commercial bulk email from paying senders. The apparatus further comprises an accounting module configured to authenticate a sender of commercial bulk email as a paying sender. The accounting module causes a charge to be applied to an account associated with the paying sender upon receipt of commercial bulk email from the paying sender.

In another embodiment of the present invention, an apparatus comprises a first instruction configured to identify a sender of an email and determine if the sender is a paying sender. The apparatus further comprises a second instruction configured to determine if a recipient of the email has elected to receive nonpaying email from the sender. The apparatus further comprises a third instruction configured to determine if a recipient of the email has elected to receive commercial bulk email from a paying sender. The apparatus further comprises a fourth instruction configured to determine if the email is commercial bulk email. The apparatus further comprises a fifth instruction configured to deliver the email to an inbox folder or a junk mail folder based on the determinations made in the first and fourth instructions, and at least one of the second and third instructions.

### BRIEF DESCRIPTION OF THE DRAWINGS

FIG. 1 is a flowchart illustrating the operation of an exemplary embodiment of a postage-based email processing system wherein the user is provided with the option of opting out of receiving paid CBE.

FIG. 2 is a schematic diagram illustrating the postage-based email processing system of FIG. 1.

FIG. 3 is a flowchart illustrating the operation of an exemplary embodiment of a postage-based email processing system wherein the user is not provided with the option of opting out of receiving paid CBE.

FIG. 4 is a flowchart illustrating the operation of an exemplary embodiment of a postage-based email processing system wherein incoming email without postage is not delivered to the addressee's inbox.

FIG. 5 is a schematic diagram illustrating an exemplary email processing system using secure tokens to authenticate CBE senders.

### DETAILED DESCRIPTION OF PREFERRED EMBODIMENTS

In some conventional email processing systems, incoming email is distributed directly into users' inboxes according to addressee information contained within the email. As described above, CBE filters are often used with conventional email processing systems. CBE filters are usually configured to route email identified as CBE to a user's “junk folder” that is distinct from the user's inbox folder. For example, the junk folder can be separate folder from the inbox folder, or can be a subfolder of the inbox folder. The junk folder is typically the designated location for email such as CBE or other unwanted email, such as email having undesirable characteristics, including email soliciting unwanted products or email containing offensive subject matter. The junk folder can have other names, such as “trash,” “deleted items,” and the like. Often, the junk folder is configured to be automatically emptied on a periodic basis.

As used herein, the terms “junk folder” and “inbox folder” refer, in addition to file folders, and in addition to their ordinary meanings, to other methods for organizing email for a user's convenience. CBE filters represent an attempt to mitigate the burden of reviewing and filtering the CBE that would otherwise be routed directly into a user's inbox. CBE filters can be installed at the Internet service provider level such that intercepted CBE never reaches users, or at the user level thereby providing individual users with greater ability to control and monitor the operation of the filter.

Few, if any, CBE filters are absolutely effective in accurately identifying all incoming email as CBE or not CBE. Even if a CBE filter allows only a small percentage of CBE to pass through the filter undetected, such as 0.1% or less, this amount of CBE can still cause great inconvenience to individual users. In particular, because senders of CBE can easily send large quantities of CBE without incurring significant costs, filters can often be neutralized by simply increasing the volume of incoming CBE. The effectiveness of CBE filters is further limited by CBE senders' rapidly advancing ability to send CBE that is effectively disguised as genuine solicited email, thereby circumventing the filter's ability to detect CBE.

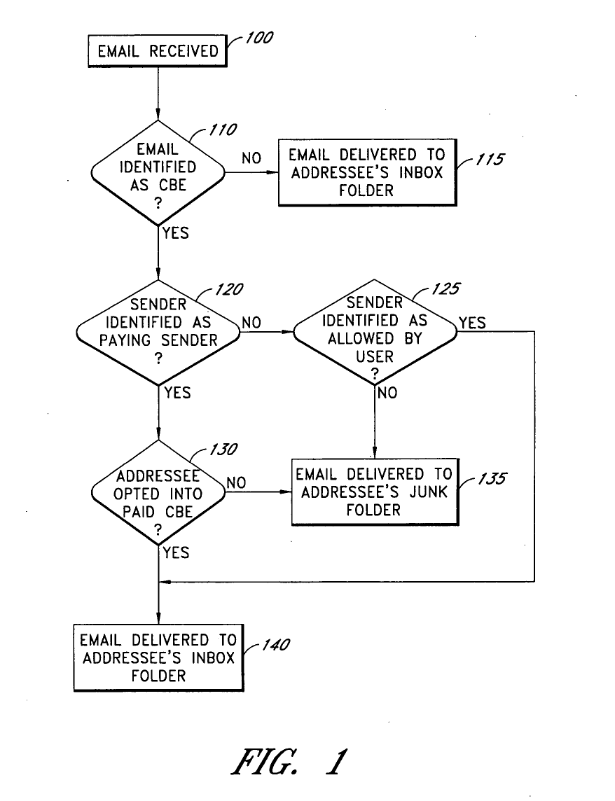

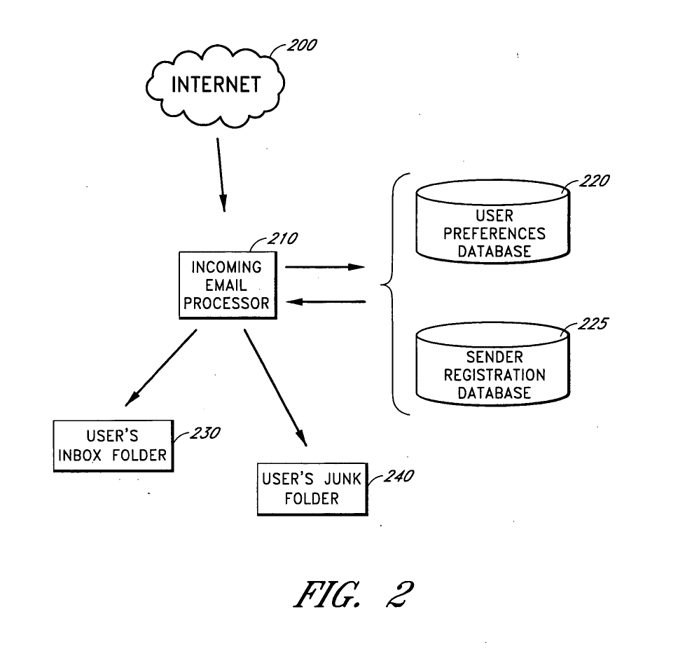

These difficulties are addressed in an exemplary embodiment of the postage-based email processing system disclosed herein and illustrated in FIGS. 1 and 2. By way of example, this system can be implemented using instructions, modules, and/or the like that are executed on or by one or more computer systems. As illustrated in FIGS. 1 and 2, an incoming email processor 210 is capable of receiving email from the Internet 200 in an operational block 100. The incoming email processor 210 then routes the email according to a series of tests, as illustrated in FIG. 1, and as described in greater detail below.

The incoming email processor 210 first determines whether the incoming email can be identified as CBE in decisional block 110. This determination can be performed at an organizational level, at the Internet service provider level, at the user level or at another level. However, by testing incoming email for CBE status closer to the point of receipt from the Internet or other public network, fewer network resources can be spent routing the CBE.

Regardless of when the email is tested for CBE status, the CBE determination can be accomplished using a wide variety of techniques. For example, in one embodiment, the identity of the sender is checked against a list of known senders of CBE, such as can be stored in a database or other data store. An exemplary database is the sender registration database 225 illustrated in FIG. 2. Such a database can be compiled by the incoming email processor 210, by other software applications, by the collective efforts of individual users, or by some combination of the above. In another embodiment, email sending patterns from a particular sender are analyzed for indicia of CBE, such as a large number of emails (for example, a number greater than a preset threshold) sent from a single sender to multiple recipients in a short time period. In still other embodiments, other CBE detection algorithms can be used in decisional block 110, including other algorithms that are developed in the future. In addition, the content of the incoming emails can be analyzed for certain keywords prevalent in CBE, such as “free”, “Viagra” and the like. Furthermore, several of the algorithms listed here can be used in combination to enhance the CBE identification decisional block 110. If the incoming mail processor 210 determines that the incoming email is not CBE, the incoming email is delivered to the user's inbox folder 230 in operational block 115.

However, if the incoming mail processor 210 determines that the incoming email is CBE, the incoming mail processor 210 then identifies the sender of the CBE as a paying sender or a nonpaying sender in decisional block 120. As used herein, a “paying sender” is a sender of CBE that has paid a postage fee in exchange for a prioritized handling of its CBE. The postage fee can be paid to the addressee, the Internet service provider, a governmental agency, or another entity, or any combination thereof. The postage fee can be paid in advance, or can be charged to an account for which the CBE sender is billed on a recurring basis. In a modified embodiment, the postage fee can be a flat fee paid on a recurring basis, such as a pre-established monthly fee. As used herein, a “nonpaying sender” is a sender of CBE that has not paid the postage fee.

A CBE sender's payment of the postage fee can be used to advantageously subsidize the recipient's email service. For example, in one embodiment the email recipient will be directly paid to receive a CBE. In such an embodiment, the recipient will be more likely to review the contents of the CBE, thus benefiting the sender. In addition, if the Internet service provider receives all or a portion of the postage fee, the Internet service provider can recapture the cost of administering CBE manipulation software.

In the exemplary embodiment illustrated in FIG. 2, a list of paying senders is maintained in a sender registration database 225, also known as a “white list”. Thus, when the incoming email processor 210 detects incoming CBE, the incoming email processor 210 queries the sender registration database 225 to determine whether the sender of the CBE is a paying sender in decisional block 120. If the sender is registered in the sender registration database 225 as a paying sender, then operation proceeds to decisional block 130. Conversely, if the sender is not registered in the sender registration database 225 as a paying sender, then operation proceeds to decisional block 125.

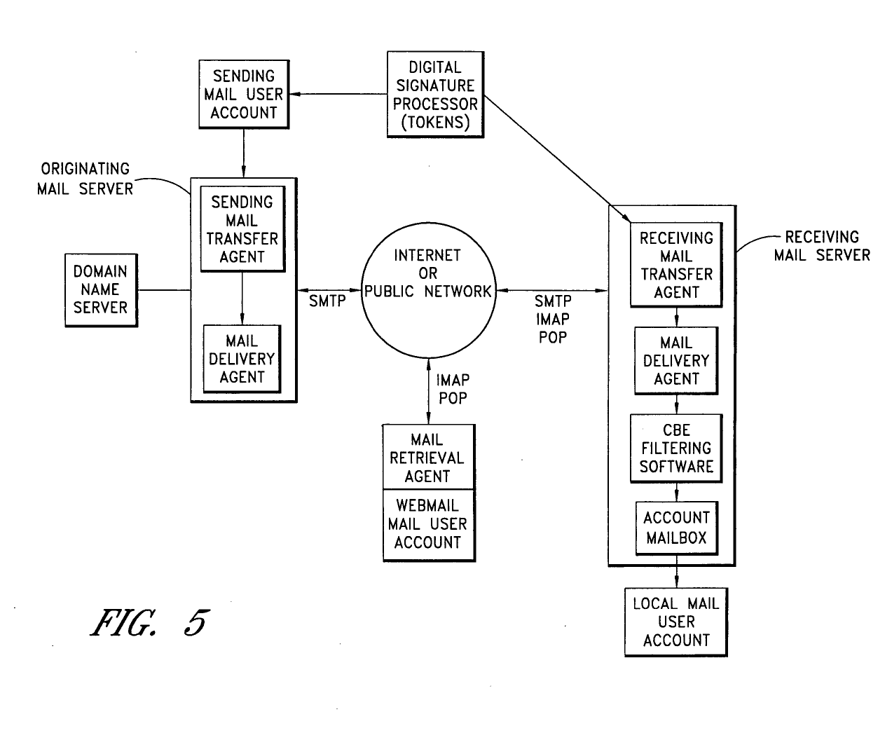

In a modified embodiment, illustrated in FIG. 5, the CBE sender authenticates itself as a paying sender by including a secure token or other identifier in its emails. The secure token can be obtained from a third party digital signature processor, which can also be configured to authenticate the secure token for the receiving mail server. In certain embodiments, the third party digital signature processor can also be configured to administer the distribution of revenues received from secure token sales to CBE stakeholders, such as user recipients, Internet service provider recipients, and third parties. The CBE sender can acquire the secure token by paying a postage fee as described above. In such embodiments, the incoming mail processor 210 is configured to screen incoming mail for the secure token; if the secure token is identified in incoming CBE, then the incoming CBE is authenticated as paid CBE.

In decisional block 125, the incoming mail processor 210 determines whether the CBE addressee has elected to receive email from the nonpaying CBE sender. This determination can be based on individual preferences set by the addressee and stored in the user preferences database 220. For example, if a user wishes to receive CBE from a particular nonpaying CBE sender, such as a preferred vendor or a company that the user is considering patronizing, the user can register that CBE sender as “allowed” by the user. If the CBE sender is identified as allowed by the user, then the CBE is delivered to the user's inbox folder 230 in operational block 140. In contrast, if the CBE sender is identified as not allowed by the user, then the CBE is delivered to the user's junk folder 240 in an operational block 135. This configuration advantageously allows the user to “opt-in” to receive CBE from selected CBE senders.

In decisional block 130, the incoming mail processor 210 determines whether the CBE addressee has elected to receive CBE from a paying sender. This determination can be based on individual preferences set by the addressee and stored in the user preferences database 220. Specifically, if a user wishes to receive CBE from paying senders, the user can register these preferences with the user preferences database 220. For example, a user may register to receive CBE from a paying sender if the user thinks that such messages will have higher relevancy or will contain commercial offers with enhanced value. The user can register to receive CBE from a paying sender for any number of other reasons as well, such as a desire to have the cost of email service subsidized by the CBE sender. If the CBE addressee has elected to receive CBE from a paying sender, then the CBE is delivered to the user's inbox folder 230 in operational block 140. In contrast, if the CBE addressee has not elected to receive CBE from a paying sender, then the CBE is delivered to the user's junk folder 240 in operational block 135. This configuration advantageously allows the user to “opt-in” to receive CBE from paying senders.

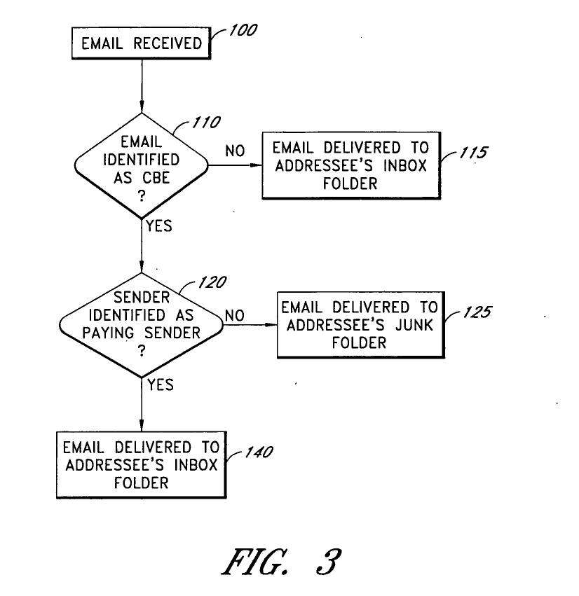

In a modified embodiment, illustrated in FIG. 3, the addressee is not provided with the option of opting out of receiving paid CBE. As illustrated in FIG. 3, if incoming email is identified as CBE, and if the sender is identified as a paying sender, then the email is delivered to the addressee's inbox folder without consideration of the addressee's preferences with respect to receiving paid CBE. For paid CBE senders, such an embodiment provides an increased inbox delivery rate for paid CBE.

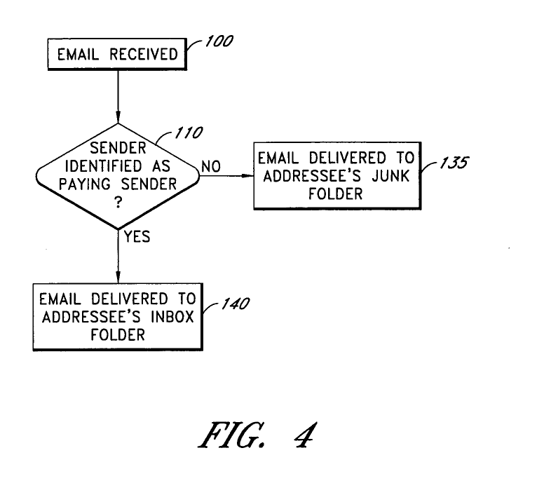

In another modified embodiment, illustrated in FIG. 4, the incoming mail processor 210 is configured to route all incoming email without postage to the addressee's junk folder. In other embodiments, the nonpaying incoming mail can be deleted or otherwise be prevented from reaching the user. In either of such embodiments, the incoming mail processor can be further configured to send a standardized response to the nonpaying sender advising of the requirement to pay a postage fee, and providing instructions for doing so.

The various embodiments of the postage-based email processing system described herein offer several advantages over conventional systems. For example, requiring senders of CBE to pay a postage fee in exchange for prioritized handling of CBE provides a disincentive for senders of CBE to increase yield rates by simply increasing the volume of mail sent. Moreover, requiring senders of CBE to pay a postage fee to reach an addressee will provide an incentive for senders of CBE to deliver more modest quantities of CBE. In embodiments wherein the postage fees are paid to Internet service providers and/or mail recipients, the activities of CBE senders can serve as a payment to those entities and users that bear the burden of unchecked CBE in conventional email processing systems. In addition, by storing user preferences with respect to receiving CBE from particular senders and receiving nonpaying CBE, the CBE that is delivered into a user's inbox folder will generally have increased relevancy as compared to conventional email filtering systems.

### Scope of the Invention

While the foregoing detailed description has described several embodiments of the present invention, it should be understood that the above description is illustrative only and is not limiting of the disclosed invention. It will be appreciated that the specific configurations and operations disclosed can differ from those described above, and that the methods described herein can be used in contexts other than electronic mail processing.

1. An email processing system comprising:
a first database configured to store a user's email routing preferences;
a second database configured to store registration information on paying email senders,
email identification analysis code configured to determine whether an incoming email is commercial bulk email; and
email routing code configured to selectively deliver the incoming email to a folder, wherein the folder is an inbox folder or a junk mail folder, or to prevent the incoming email from reaching the user, based at least partially on
the user's email routing preferences,
the determination of the email identification analysis code, and
the email sender registration information,
wherein the email routing code is configured to deliver the incoming email to the junk folder if the email identification analysis code determines that the incoming email is commercial bulk email, the email sender is a paying sender, and the user's email routing preferences indicate that commercial bulk email from a paying sender is to be delivered to the junk mail folder.

2. The email processing system of claim 1, further comprising a digital signature processor configured to authenticate the email sender.

3. The email processing system of claim 1, wherein the email routing code is configured to deliver the incoming email to the inbox folder if the email identification analysis code determines that the incoming email is not commercial bulk email.

4. The email processing system of claim 1, wherein the email routing code is configured to deliver the incoming email to the junk mail folder if
the email identification analysis code determines that the incoming email is commercial bulk email,
the email sender is a nonpaying sender, and
the user's email routing preferences indicate that commercial bulk email from a nonpaying sender is to be delivered to the junk mail folder.

5. The email processing system of claim 1, wherein the email routing code is configured to prevent the incoming email from reaching the user if
the email identification analysis code determines that the incoming email is commercial bulk email,
the email sender is a nonpaying sender, and
the user's email routing preferences indicate that commercial bulk email from a nonpaying sender is not to be delivered to the user.

6. The email processing system of claim 1, wherein the email routing code is configured to deliver the incoming email to the inbox folder if
the email identification analysis code determines that the incoming email is commercial bulk email,
the email sender is a nonpaying sender, and
the user's email routing preferences indicate that commercial bulk email from a nonpaying sender is to be delivered to the inbox folder.

7. The email processing system of claim 1, wherein the email routing code is configured to deliver the incoming email to the inbox folder if
the email identification analysis code determines that the incoming email is commercial bulk email,
the email sender is a paying sender, and
the user's email routing preferences indicate that commercial bulk email from a paying sender is to be delivered to the inbox folder.

8. A method for processing email comprising:
receiving an incoming email addressed to a recipient;
identifying a sender of the incoming email and determining if the sender is a paying sender;
determining if the recipient has elected to receive nonpaying email from the sender;
determining if the recipient has elected to receive commercial bulk email from paying senders;
determining if the incoming email is commercial bulk email;
if the incoming email is not determined to be commercial bulk email, delivering the incoming email to an inbox folder; and
if the incoming email is determined to be commercial bulk email
(a) delivering the incoming email to a junk mail folder if the sender is not a paying sender and if the recipient has not elected to receive nonpaying email from the sender;
(b) delivering the incoming email to an inbox folder if the sender is not a paying sender and if the recipient has elected to receive nonpaying email from the sender;
(c) delivering the incoming email to a junk mail folder if the sender is a paying sender and if the recipient has not elected to receive paying email from the sender;
(d) delivering the incoming email to an inbox folder if the sender is a paying sender and if the recipient has elected to receive paying email from paying senders.

9. The method of claim 8, further comprising storing a recipient's email routing preferences and a sender's payment status in a database.

10. The method of claim 8, wherein the sender is identified as a paying sender using a secure token embedded in the incoming email.

11. The method of claim 8, wherein the sender is identified as a paying sender using a secure token that is embedded in the incoming email and that is issued and authenticated by a digital signature processor.

12. An apparatus comprising:
code, which when executed is configured to selectively deliver an incoming email to an inbox folder or a junk mail folder based on first and second user preference settings, wherein the first user preference setting controls whether an email recipient receives nonpaying emails from a particular sender, and wherein the second user preference setting controls whether an email recipient receives commercial bulk email from paying senders in the inbox folder; and
an accounting module configured to authenticate a sender of commercial bulk email as a paying sender, wherein the accounting module causes a charge to be applied to an account associated with the paying sender upon receipt of commercial bulk email from the paying sender in the inbox folder.

13. The apparatus of claim 12, further comprising a database configured to store first and second user preference settings for a plurality of users.

14. The apparatus of claim 12, wherein the accounting module is further configured to periodically compile a list of charges associated with the sender of commercial bulk email.

15. The apparatus of claim 12, wherein the accounting module authenticates a paying sender of commercial bulk email using a secure token embedded in the email.

16. The apparatus of claim 12, wherein the accounting module uses a digital signature processor to authenticate the sender of commercial bulk email.

17. The apparatus of claim 12, wherein the accounting module authenticates the paying sender of commercial bulk email using a secure token embedded in the email.

18. The apparatus of claim 12, wherein an incoming paid commercial bulk email includes a secure token, and wherein the accounting module authenticates the secure token using a digital signature processor.

19. An apparatus comprising:
a first instruction configured to identify a sender of an email and determine if the sender is a paying sender;
a second instruction configured to determine if a recipient of the email has elected to receive nonpaying email from the sender;
a third instruction configured to determine if a recipient of the email has elected to receive commercial bulk email from a paying sender;
a fourth instruction configured to determine if the email is commercial bulk email; and
a fifth instruction configured to deliver the email to an inbox folder or a junk mail folder based on the determinations made by the first and fourth instructions, and at least one of the second and third instructions.

20. The apparatus of claim 19, wherein the determination made in the first instruction is based on whether a secure token is included in the email.

21. The apparatus of claim 19, wherein the determination made by the first instruction is performed by a digital signature processor that authenticates a secure token included in the email.

22. The apparatus of claim 19, further comprising a server that hosts the first, second, third, fourth and fifth instructions.
